(19) United States
(12) Patent Application Publication
(10) Pub. No.: US 2014/0073996 A1
(43) Pub. Date: Mar. 13, 2014

(54) Portable Relaxation Therapy Massage Device for the Head

(71) Applicant: Mauro Jaguan, Caracas (VE)

(72) Inventor: Mauro Jaguan, Caracas (VE)

(21) Appl. No.: 13/612,718

(22) Filed: Sep. 12, 2012

(51) Int. Cl. A61H 1/00

(52) U.S. Cl. 601/15

(57) ABSTRACT

A portable relaxation therapy massage device for administering spray fluid therapy to the head comprised of: 1) A helmet that fits over the head with multiple spray jets; 2) A reservoir for holding various therapeutic liquids and substances, such as water and ice; 3) A first pump for pumping the therapeutic liquids in the reservoir to the helmet to be sprayed onto the head and neck of the user; and, 4) A second pump for returning the expelled liquids back to the reservoir for subsequent reuse. The interior of the helmet also includes a multiplicity of sources of colored light to provide craniofacial chromotherapy. In combination, spray fluid therapy and chromotherapy provide a relaxing and refreshing stimulative experience for the head.

### CROSS-REFERENCE TO RELATED APPLICATIONS

This application takes benefit of U.S. Provisional App. 61/533496 dated Sep. 12, 2011 which is incorporated herein by reference.

### FIELD OF THE INVENTION

The present invention comprises: A portable device for administering fluid therapy using pressurized water and/or other therapeutic fluids and/or substances to massage and relax the head and scalp of the user while simultaneously allowing the use of craniofacial chromotherapy thus providing a generally relaxing and refreshing stimulative experience for the head.

### BACKGROUND OF THE INVENTION

It is well known that merely standing in a shower with a stream of water directed at one's body results in a stimulating and relaxing effect in and about the area on which the water impinges. Many inventions for applying one or more streams of water to the body are well known in the prior art. Such devices range from mere handheld devices (e.g. a handheld shower massager) through more complex devices that subject the user's entire body to a multiplicity of streams of water and/or steam and/or entrained air (e.g. a therapeutic shower cabinet or whirlpool bath). Moreover, it is well known that variations in the temperature of the impinging water act to vary the stimulative or relaxing effect. Cold water causes one set of sensations, hot water causes another.

These effects are equally effective when applied directly to the head, particularly as a means of decreasing or eliminating head and neck pain and discomfort. A stream of water naturally acts to decrease tension in the muscles of the head and face, thus lessening stress related headaches. Some people report that a hot or warm water spray applied to the head lessens headache. By the same token, a stream of cold water applied to a greater area of the scalp lowers the temperature of the scalp, thus causing the vasculature of the scalp to constrict slightly. Some people feel this helps alleviate headaches. Other therapeutic effects may be obtained by means of decreasing intra-cranial blood pressure thus preventing and/or treating some forms of stroke and/or facilitating more rapid recovery from cranial concussion. To achieve these effects water and/or other therapeutic fluids and/or substances may be sprayed or misted onto the scalp in a variety of temperatures, from cold to hot. Therapeutic fluids include, but are not limited to, carbonated water, tonic water, and astringent liquids. Therapeutic substances include, but are not limited to ice, bathing salts, and sea salt.

However, no such device exists in the prior art to apply one or more jets of water and/or other therapeutic fluids and/or substances to the head, and only the head of the user. If one wishes to partake of such therapy using devices presently extant in the prior art, one must either take a shower or bath. The apparatus required by these existing techniques has the added disadvantage of being non-portable, essentially tying the user to a fixed location. Moreover, the necessity of disrobing to enjoy these existing therapies adds to their complexity and inconvenience.

Similarly, the use of colored light (chromotherapy or light therapy) as a therapeutic regimen is well known in the prior art both to practitioners of Ayurvedic medicine and photobiology. Chromotherapy is variously believed to induce feelings of well-being or “balance” various “energies” in the body (i.e. physical, emotional, spiritual, or mental) and/or treat specific sleep, skin, and mood disorders. While various devices are known in the prior art that combine shower heads, full sized bathtubs, and full-sized shower cabinets with chromotherapeutic devices, none are known that allow selective chromotherapy in the region of the face and neck. Thus, to the extent phototherapy is effective solely when administered through the eyes and the skin of the head and scalp, a portable apparatus that administers such therapy either independently or in concert with the fluid therapy described above would be advantageous.

### SUMMARY OF THE INVENTION

It is an object of the present invention to provide a portable device that can be used to administer fluid therapy by spraying a multiplicity of jets of water and/or other therapeutic fluids and/or substances, at varying pressures and in varying patterns onto the head, and only the head, of the user. These jets of water and/or other therapeutic fluids and/or substances may be deposited on the scalp in any one of a variety of temperatures ranging from hot to cold, or any combination in between. Therapeutic fluids include, but are not limited to, carbonated water, tonic water, and astringent liquids. Therapeutic substances include, but are not limited to, ice, bathing salts, and sea salt. It is a second object of the present invention to provide a portable device that can be used to administer chromotherapy to the head of the user. Such chromotherapy is administrable in a variety of colors and intensities—from individual single color therapy to variable color therapy, such colors being derived by varying the intensity of independent red, green, and blue light sources. It is a third object of the present invention to provide a portable device that can be used to simultaneously administer fluid therapy and chromotherapy to the head of the user. Other embodiments of the present invention allow the user to apply cooled and heated air or bottled gasses such as oxygen to the head simultaneously with therapeutic fluid and/or chromotherapy. Still another embodiment allows the user to enjoy aromatherapy simultaneously with therapeutic fluid and/or chromotherapy.

The device is comprised of a helmet which loosely encircles the entire head with the exception of the anterior portion of the neck and the oronasal area of the face. The occipital area of the inside aspect of the helmet is equipped with a circular or ovoid cushion encircling a drain port with filter disc cover. The cushion is perforated about its bottom periphery to allow fluid that is sprayed on the head to subsequently drip to the back of the helmet to flow through the cushion, through the filter, and into the drain. The drain perforates the helmet to a tube attachment point which is attached to a suction drain line. A suction drain line attaches to the input port of a first pump. The inner aspect of the helmet is perforated around its roughly spherical inner surface by a number of spray ports. These spray ports communicate through the helmet to individual tube attachment points each one of which is attached to a pressurized spray line. Each pressurized spray line is in turn connected to a corresponding output port on a distribution manifold. The input port of the distribution manifold is in turn connected to a pressurized feed line which is in turn attached to the output of a second pump.

Adjacent to the helmet is a fluid reservoir. This fluid reservoir has a capped drain port near its bottom to allow the user to drain the reservoir by means of gravity. On the top of the fluid reservoir is a hinged door or access port to allow the introduction of ice, water, and such into the fluid reservoir. Penetrating from the top of the reservoir and extending to the bottom of the reservoir are a suction pickup line and a drain discharge line. Each of these terminates on the outside surface of the reservoir at a tube connection point. A pressurized drain line connects the tube attachment point associated with the drain discharge line to the output port of the first pump. Optionally, all or part of this pressurized drain line is composed of some ultraviolet radiation resistant transparent material such as acrylic, glass, or Tygon® tubing and passes in close proximity to an ultraviolet light so as to sterilize the fluid before it is returned to the tank. A suction feed line connects the tube attachment point associated with the suction pickup line to the input port of the second pump.

The first pump and the second pump are electrically wired in series to a power supply operated by means of a pump switch. When the user actuates the pump switch both pumps are energized and begin to pump.

Attached to the roughly spherical inner aspect of the helmet in such a way as to not block any of the spray ports present on the inner aspect of the helmet are a multiplicity of LED light strips or equivalent sources of colored light. These LED light strips can be monochromatic (i.e. all constituent LEDs in the LED light strip are the same color) or multi-colored (i.e. each LED light strip contains a continuously alternating sequence of red, green, and blue LEDs). In either case, each LED of each color in each LED light strip is wired in parallel with every other LED of the same color in every other LED light strip. By this means, all LEDs of the same color in all LED light strips are connected to a light control unit that can independently vary the intensity of all LEDs of the same color in all LED light strips simultaneously. The light control unit is in turn wired to the aforementioned power supply and to two controls: 1) An intensity control; and, 2) A color control. In the case of monochromatic LED light strips, the user operates the intensity control to simultaneously vary the intensity of the light emitted by the LEDs in the LED light strips, thus varying the intensity of the monochromatic light generated inside the helmet. In the case of LED light strips with LEDs arranged in a continuously alternating sequence of red, green, and blue, the user operates the color control to cause the light control unit to independently vary the relative output of all of the LEDs of the same color in all of the LED light strips such that additively they generate a variable color inside the helmet ranging from black (no light) to red to green to violet to white. The user then operates the intensity control to vary the intensity of the light thus additively generated by the multiplicity of red, green and blue LEDs in the multiplicity of LED light strips.

A decorative shroud fits down over the aforementioned components when they are assembled and covers them with the exception of previously described portion of the helmet and the top of the storage tank so as to allow the user to access the storage tank and place water and therapeutic substance in the tank. This decorative shroud contains a depression in the area adjacent to the user's forehead when the head is inserted into the helmet for the accurate placement of gemstones in the vicinity of the forehead Chakra (equidistant between the eyebrows).

To operate the device to administer fluid therapy, the user pours water and/or therapeutic fluids and/or substances into the storage tank. The user places the device on the floor or on another suitable flat surface. The user then lies on the floor or other flat surface, and inserts his head, face up, into the helmet through the opening provided for the user's head and neck. The user then rests his head on the circular or ovoid cushion and activates the first and second pump via the pump switch and enjoys the stimulating and refreshing flow of the water and/or therapeutic fluids and/or other substances present in the storage tank as they are expelled under pressure onto the user's scalp and neck. The water and/or therapeutic fluids and/or substances then drain through the circular or ovoid cushion, through the filter, where they are collected by the second pump, returned to the storage tank, and the process repeats.

To operate the device to administer chromotherapy, the user places the device on the floor or on another suitable flat surface. The user then lies on the floor or other flat surface, and inserts his head, face up, into the helmet through the opening provided for the user's head and neck. The user then rests his head on the circular or ovoid cushion and activates the light control unit by actuating the color control and the intensity control to create a colored light of the desired color and intensity.

To enjoy fluid therapy and chromotherapy simultaneously, the user pours water and/or therapeutic fluids and/or substances into the storage tank. The user places the device on the floor or on another suitable flat surface. The user then lies on the floor or other flat surface, and inserts his head, face up, into the helmet through the opening provided for the user's head and neck. The user then rests his head on the circular or ovoid cushion and activates the first and second pumps via the pump switch and enjoys the stimulating and refreshing flow of the water and/or therapeutic fluids and/or other substances present in the storage tank as they are expelled under pressure onto the user's scalp and neck. The water and/or therapeutic fluids and/or substances then drain through the circular or ovoid cushion, through the filter, where they are collected by the second pump, returned to the storage tank, and the process repeats. Simultaneously, the user activates the light control unit by actuating the color control and the intensity control to create a colored light of the desired color and intensity.

### BRIEF DESCRIPTION OF THE DRAWINGS

FIG. 1 is a three-quarter view of the left-hand side of present invention with the decorative shroud that encloses the entire device removed.

FIG. 2 is a three-quarter view of the right-hand side of present invention with the decorative shroud that encloses the entire device removed.

FIG. 3 is a schematic diagram illustrating the fluid and electrical system of one embodiment of the present invention.

FIG. 4 is a schematic diagram illustrating the fluid and electrical system of a second embodiment of the present invention.

FIG. 5 is a schematic diagram illustrating the fluid and electrical system of a third embodiment of the present invention.

FIG. 6 is a schematic diagram illustrating the fluid and electrical system of a fourth embodiment of the present invention.

### DETAILED DESCRIPTION OF THE INVENTION

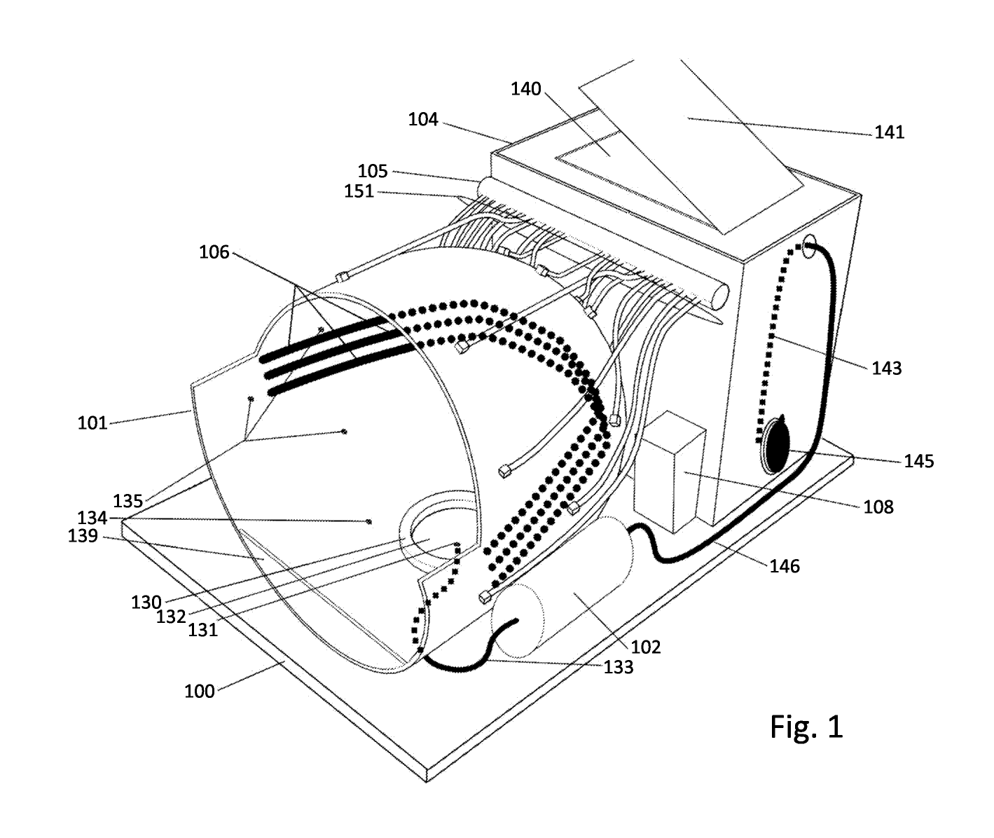

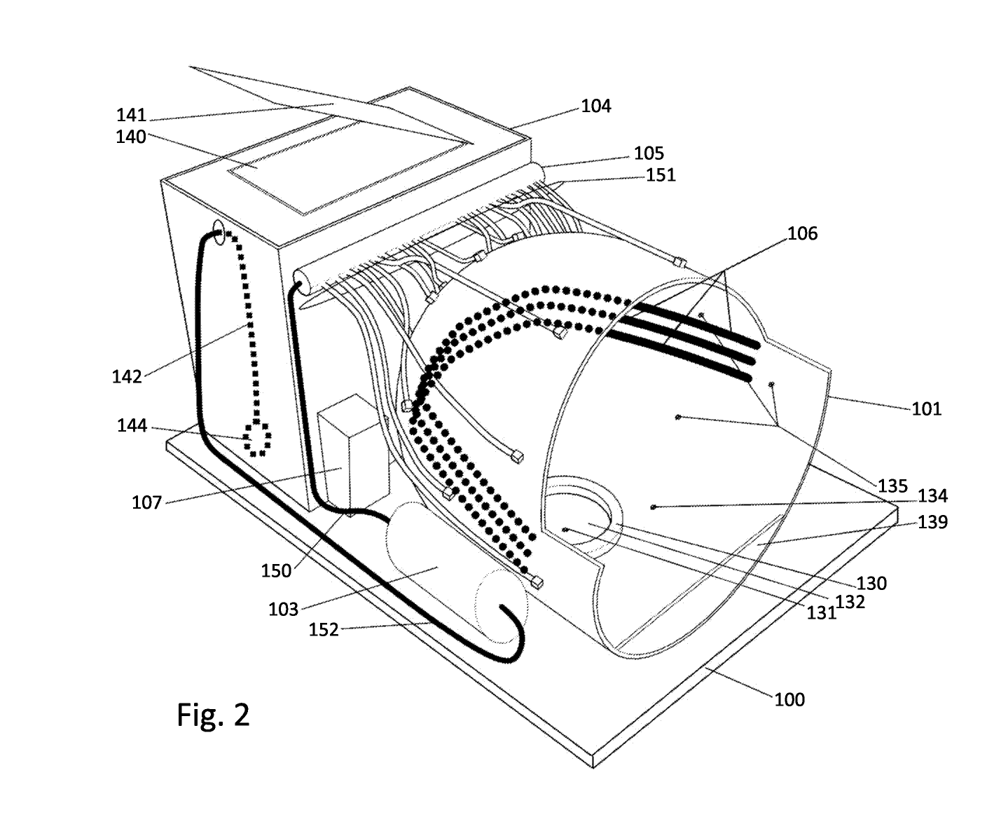

Turning now to FIGS. 1, 2, and 3 one embodiment of the present invention is comprised of support box 100, helmet 101, first pumping means 102, second pumping means 103, reservoir 104, distribution manifold 105, LED light strips 106, light control unit 107, power supply 108, color control means 109, intensity control means 110, and switching means 111.

Support box 100 is in the general form of a shallow rectangular prism. Support box 100 provides a stable flat base for helmet 101, reservoir 104, and other components. A decorative shroud fits down over the assembled components and covers them with the exception of the open portion of helmet 101 and the top of reservoir 104. This decorative shroud contains a depression in the area adjacent to the user's forehead when the head is inserted into the underlying helmet for the accurate placement of gemstones in the vicinity of the forehead Chakra (equidistant between the eyebrows).

Helmet 101 is constructed of plastic, acrylic, or a similar substance and is preferably molded or vacuum formed. Helmet 101 is loose-fitting to the head and in the general form of an elongated sphere which encircles the entire head with the exception of the anterior portion of the neck and the oronasal area of the face thus allowing for the insertion of the user's head and neck. The occipital area of the inside aspect of the helmet 101 is equipped with a circular or ovoid cushion 130 encircling drain 131. Cushion 130 is perforated about its bottom periphery to allow fluid sprayed on the head to subsequently drip to the back of the helmet to flow through cushion 130, through filter disc 132, and into drain 131. Drain 131 perforates helmet 101 to provide tube attachment point which is attached to suction drain line 133. The inner aspect of helmet 101 is perforated around its roughly spherical inner surface by a multiplicity of spray ports 134 and 135 (shown) and 136, 137, and 138 (not shown). Spray ports 134, 135, 136, 137, and 138 are positioned such that water and/or therapeutic fluids and/or substances pumped through them and sprayed on the head of the user fall in specific locations on the user's head. Specifically: 1) Spray ports 134 apply fluid to the occipital and cerebellar areas of the head and neck; 2) Spray ports 135 apply fluid to the temporal aspects of the head; 3) Spray ports 136 apply fluid to the parietal aspects of the head; 4) Spray ports 137 apply fluid to the frontal aspects of the head, particularly the forehead; and, 5) Spray ports 138 apply fluid to the ocular region of the head particularly the area around the eyes. While spray ports 134, 135, 136, and 137 deliver the same, relatively higher volume of fluid to their respective regions of the head, spray ports 138 deliver a smaller volume of fluid to the ocular region of the head. Each of spray ports 134, 135, 136, 137, and 138 communicate through helmet 101 to an individual tube attachment point. A partition 139 is provided along the posterior aspect of the bottom lip of helmet 101 that prevents fluid sprayed on the head of the user from flowing out of the helmet so that it might be returned to reservoir 104 by means of drain 131. Helmet 101 is attached to support box 100 in such a way that the tube attachment point associated with drain 131 protrudes into support box 100. When affixed this way, the opening in helmet 101 revealing the oronasal region of the face and neck of the user points directly, or nearly directly, up. Support box 100 is substantially greater in length than helmet 101 is in diameter, thus allowing support box 100 to extend below and above helmet 101 when viewed directly from above.

First pumping means 102 is any of the usual kind of electrically powered centrifugal or positive displacement type pump well known in the art. First pumping means 102 is attached to the top of support box 100 adjacent to helmet 101.

Similarly, second pumping means 103 is any of the usual kind of electrically powered centrifugal or positive displacement type pump well known in the art. Second pumping means 103 is similarly attached to the top of support box 100 adjacent to helmet 101.

Reservoir 104 in the form of a rectangular prism is mounted on the upper surface of the upper protruding edge of support box 100 and serves to contain water and/or therapeutic fluids and/or substances. Reservoir 104 has an access port 140 in the general form of a rectangle molded or otherwise formed through the top surface of reservoir 104. Access port 140 is covered by spring-loaded door or flap 141 or an equivalent means for covering and sealing access port 140. Water and/or therapeutic fluids and/or substances are placed inside reservoir 104 though access port 140. Penetrating from the top of reservoir 104 and extending to the bottom of reservoir 104 are a suction pickup line 142 and a drain discharge line 143. Each of these lines terminates on the outside surface of reservoir 104 at a tube connection point. Suction pickup line 142 has pickup filter 144 attached at its distal end inside reservoir 104 to prevent solid materials from being draw into second pumping means 103 and thence clogging spray ports 134, 135, 136, 137, and 138. When not in use, water and/or therapeutic fluids and/or substances may be drained from reservoir 104 by means of drain port 145.

Distribution manifold 105 is attached to reservoir 104 adjacent to helmet 101. Distribution manifold 105 has at least one input port and, and a multiplicity of output ports coextensive in number with the number of spray ports 134, 135, 136, 137, and 138 in helmet 101.

Power supply 108 is attached to the top surface of support box 100 between helmet 101 and reservoir 104. Power supply 108 is preferably of the low voltage AC/DC type wherein a connection to mains power is reduced to low voltage DC current.

Attached to the roughly spherical inner aspect of helmet 101 in such a way as to not block any of the aforementioned spray ports 134, 135, 136, 137, and 138 present on the inner aspect of helmet 101 are a multiplicity LED light strips 106 or equivalent sources of colored light. LED light strips 106 can be multi-colored (i.e. each of LED light strips 106 contains a continuously alternating sequence of red, green, and blue LEDs)(as shown) or monochromatic (i.e. all constituent LEDs in each of LED light strips 106 is the same color)(not shown). In either case, each LED of each color in each of LED light strips 106 is wired in parallel with every other LED of the same color in every other of LED light strips 106. By this means, all LEDs of the same color in all of LED light strips 106 are connected together to form independent color circuits.

All LEDs of the same color in all of LED light strips 106 having been connected together into independent color circuits, these independent color circuits are connected to light control unit 107 mounted on the front side of reservoir 104. Light control unit 107 provides a means of independently varying the intensity of each independent color circuit simultaneously. By this means, multi-colored LED light strips 106 are used to additively generate a variable color of light inside the helmet ranging from red to green to violet to white at any user desired intensity ranging from no light to bright light. Similarly, monochromatic LED light strips 106 are used to generate a single color inside the helmet at any user desired intensity ranging from no light to bright light.

Light control unit 107 is in turn wired to power supply 108 and two control means, such as a switch, capacitive touch sensor, or resistive touch sensor: 1) An intensity control means 110; and, 2) A color control means 109. Both intensity control means 110 and color control means 109 may be mounted in separate control housing or on the decorative shroud that encloses the entire device. In the case of multi-colored LED light strips 106 with each with LEDs arranged in a continuously alternating sequence of red, green, and blue, the user operates color control means 109 to cause the light control unit 107 to independently vary the relative output of all of the LEDs of the same color in all of LED light strips 106 such that additively they generate a variable color inside the helmet ranging from red to green to violet to white. Light control unit 107 does this by varying the relative intensity of each independent color circuit by applying pulse wave modulated (PWM) current to each independent color circuit to create a fixed length pulse period with continuously variable “on” and “off” states for the associated independent color circuit. By applying no current to a particular independent color circuit for the entire pulse period, (i.e. no “on” state) the independent color circuit is not illuminated. By applying current to a particular independent color circuit for the entire pulse period, (i.e. no “off” state) the independent color circuit is illuminated at maximal brightness. By applying current to a particular independent color circuit for half the pulse period, (i.e. half “on” state and half “off” state) the independent color circuit is illuminated at medium brightness, and so on. Thus, by varying the relative brightness of each independent color circuit independently of one another, it is possible to generate virtually any color light inside helmet 101. The user may also operate intensity control means 110 to vary the overall intensity of the light thus additively generated by the multiplicity of red, green and blue LEDs in the multiplicity of LED light strips 106 to any user desired intensity ranging from no light to bright light. In the case of monochromatic LED light strips, the user operates intensity control means 110 to simultaneously vary the intensity of the light emitted by all of the LEDs in all of LED light strips 106 thus varying the intensity of the monochromatic light generated inside the helmet.

It will be readily apparent to those having skill in the art that numerous alternative means of illuminating the interior of helmet 101 are readily conceivable. For example, it is possible that each of LED light strips 106 is of a completely different color: one red, one green, and one blue. In such an implementation, light control unit 107 varies the intensity of each different colored LED light strip 106 independently. By this means, virtually any color light can be generated inside helmet 101. Similarly, in lieu of LED light strips 106, acrylic or Plexiglas® light channels or guides may be installed in helmet 101 each of which is illuminated by red, green, or blue LEDs mounted outside of helmet 101. As above, light control unit 107 varies the intensity of different colored LEDs independently. By this means, virtually any color of light can be generated inside helmet 101. Finally, while various types of LEDs are preferred as sources of colored light, other sources of colored light, including without limitation, light emitting electrochemical cells, and electro luminescent sheets and wires are included within the spirit and scope of the present invention. Similarly, while light controller 107 is disclosed as a simple non-programmable means of: 1) Varying the intensity of light generated inside helmet 101 when the invention comprises a monochromatic source of colored light; or, 2) Varying the color and intensity of light generated inside helmet 101, when the invention comprises a multi-colored source of colored light, light control unit 107 may alternately comprise a central processing unit and read-only memory pre-loaded with executable instructions operable on the central processing unit. In this embodiment, the user operates color control means 109 to cause the light control unit 107 to step through a series of alternating or random color output patterns that cycle from one color to the next and so on.

As discussed earlier, suction drain line 133 is attached to the tube attachment point where drain 131 perforates helmet 101. Suction drain line 133 is routed through the interior void of support box 100 and exits support box 100 adjacent to first pumping means 102 where it is attached to the input port of first pumping means 102. Pressurized drain line 146 connects between the output port of first pumping means 102 and the tube attachment point on the outside of reservoir 104 associated with drain discharge line 143 inside reservoir 104. Optionally, all or part of pressurized drain line 146 is comprised of some ultraviolet radiation resistant transparent material such as acrylic, glass, or Tygon® tubing and passes in close proximity to an ultraviolet light 147 so as to sterilize the fluid before it is returned to the reservoir 104.

Similarly, pressurized spray lines are attached to each tube attachment point present on the outer surface of helmet 101 where each spray port 134, 135, 136, 137, and 138 perforates helmet 101. Each pressurized spray line 151 is in turn connected to a corresponding output port on distribution manifold 105. The input port of distribution manifold 105 is in turn connected to pressurized feed line 150 which is in turn attached to the output of second pumping means 103. Suction feed line 152 connects between the input port of second pumping means 103 and the tube attachment point on the outside of reservoir 104 associated with suction pickup line 142 with pickup filter 144 attached at its distal end inside reservoir 104.

First pumping means 102 and second pumping means 103 are electrically connected with power supply 108 and switching means 111, such as a switch, capacitive touch sensor, or resistive touch sensor, such that when the user activates switching means 111, electrical current flows from power supply 108 through switching means 111 simultaneously activating first pumping means 102 and second pumping means 103. Optionally, if ultraviolet light 147 is installed, switching means 111 simultaneously activates ultraviolet light 147 by connecting it to power supply 108. Switching means 111 may be mounted in a separate control housing or on the decorative shroud that encloses the entire device.

To operate the device to administer fluid therapy, the user pours water and/or therapeutic fluids and/or substances into reservoir 104. Therapeutic fluids include, but are not limited to, carbonated water, tonic water, and astringent liquids. Therapeutic substances include, but are not limited to, ice, bathing salts, and sea salt. The user places the device on the floor or on another suitable flat surface. The user then lies on the floor or other flat surface, and inserts his head, face up, into helmet 101 through the opening provided for the user's head and neck. The user then rests his head on circular or ovoid cushion 130 and activates first pumping means 102, second pumping means 103, and, if equipped, ultraviolet light 147 via switching means 111. Second pumping means 103 retrieves water and/or therapeutic fluids and/or other substances from reservoir 104 via suction pickup line 142 after first passing through pickup filter 144 attached at its distal end. Water and/or therapeutic fluids and/or other substances are thence pumped under pressure into distribution manifold 105 and thence to the multiplicity of spray ports 134, 135, 136, 137, and 138 inside helmet 101 where the mixture is expelled under pressure onto the user's scalp and neck. The water and/or therapeutic fluids and/or other substances that are sprayed on the head subsequently drip to the back of helmet 101 to flow through perforations formed in the bottom periphery of cushion 130, through filter disc 132, and into drain 131 where they are evacuated by first pumping means 102, returned to reservoir 104, and the process repeats.

To operate the device to administer chromotherapy, the user places the device on the floor or on another suitable flat surface. The user then lies on the floor or other flat surface, and inserts his head, face up, into helmet 101 through the opening provided for the user's head and neck. The user then rests his head on circular or ovoid cushion 130 and activates light control unit 107. If LED light strips 106 are of the multi-colored variety, the user manipulates color control means 109 to create the color of light desired inside helmet 101 and the intensity control means 110 to adjust the colored light to the desired intensity. If LED light strips 106 are of the monochromatic variety, the user manipulates intensity control means 110 to adjust the colored light to the desired intensity.

To operate the device to administer fluid therapy and chromotherapy simultaneously, the user pours water and/or therapeutic fluids and/or substances into reservoir 104. Therapeutic fluids include, but are not limited to, carbonated water, tonic water, and astringent liquids. Therapeutic substances include, but are not limited to, ice, bathing salts, and sea salt. The user places the device on the floor or on another suitable flat surface. The user then lies on the floor or other flat surface, and inserts his head, face up, into helmet 101 through the opening provided for the user's head and neck. The user then rests his head on circular or ovoid cushion 130 and activates first pumping means 102, second pumping means 103, and, if equipped, ultraviolet light 147 via switching means 111. Second pumping means 103 retrieves water and/or therapeutic fluids and/or other substances from reservoir 104 via suction pickup line 142 after first passing through pickup filter 144 attached at its distal end. Water and/or therapeutic fluids and/or other substances are pumped under pressure into distribution manifold 105 and thence to the multiplicity of spray ports 134, 135, 136, 137, and 138 inside helmet 101 where the mixture is expelled under pressure onto the user's scalp and neck. The water and/or therapeutic fluids and/or other substances that are sprayed on the head subsequently drip to the back of helmet 101 to flow through perforations formed in the bottom periphery of cushion 130, through filter disc 132, and into drain 131 where they are evacuated by first pumping means 102, returned to reservoir 104, and the process repeats. To operate the device to simultaneously administer chromotherapy, the user activates light control unit 107. If LED light strips 106 are of the multi-colored variety, the user manipulates color control means 109 to create the color of light desired inside helmet 101 and the intensity control means 110 to adjust the colored light to the desired intensity. If LED light strips 106 are of the monochromatic variety, the user manipulates intensity control means 110 to adjust the colored light to the desired intensity.

It will be readily apparent to those having skill in the art that numerous alternative means of interconnecting the output port of second pumping means 103 and the multiplicity of spray ports 134, 135, 136, 137, and 138 are readily conceivable. For example, it is possible that the tube connection point of all of the multiplicity of spray ports 134, 135, 136, 137, and 138 except one could be in the form of a “T” whereby the output port of second pumping means 103 is connected directly to a first spray port with a “T” connection, which is in turn connected to the next spray port with a “T” connection, and so on, until the spray port without a “T” connection is last connected to the penultimate spray port in the chain with a “T” connection. By this means, it is possible to eliminate the need for distribution manifold 105.

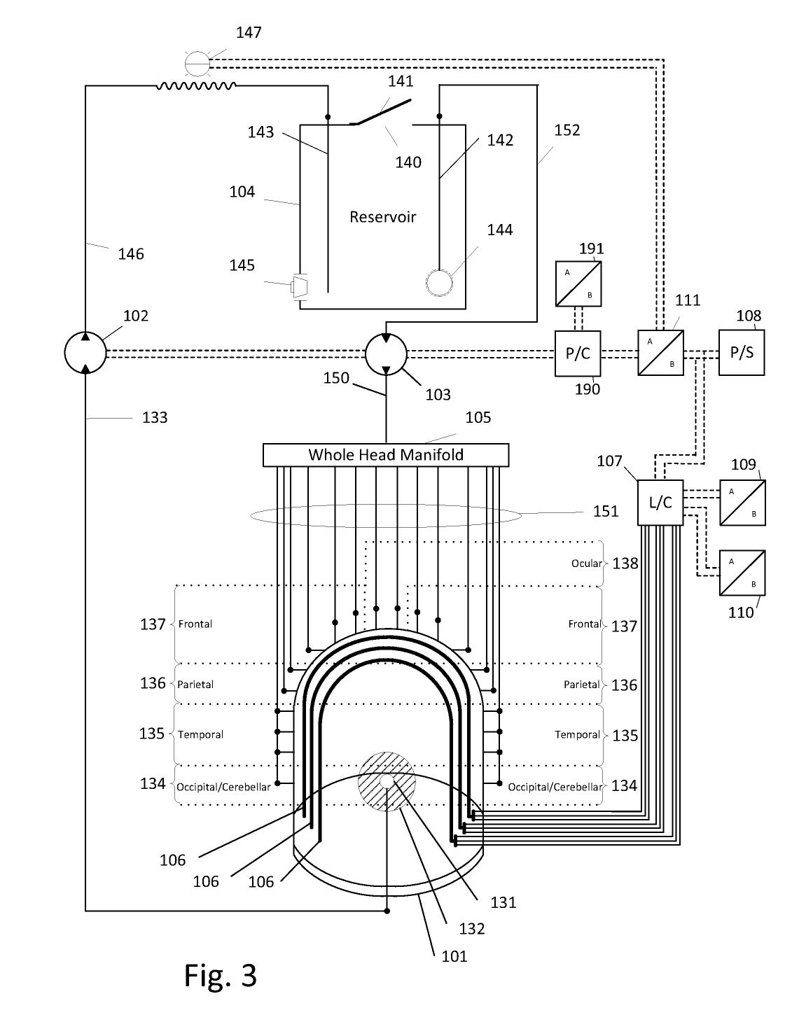

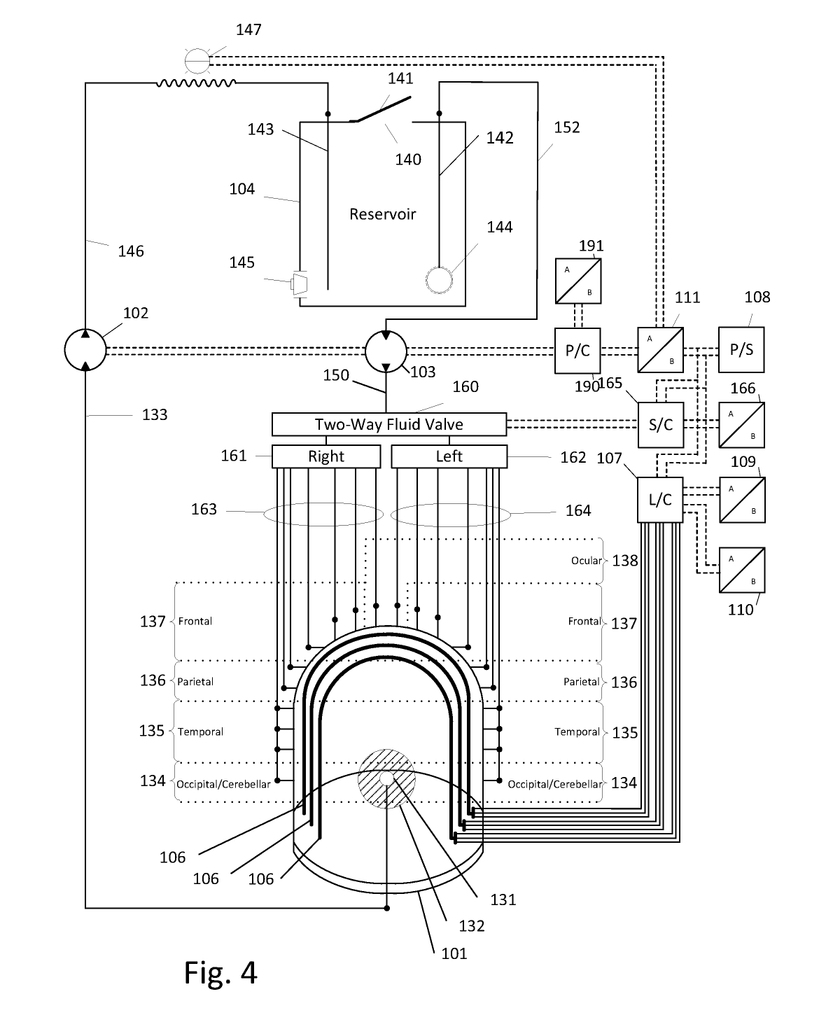

A second embodiment of the present invention is disclosed in FIG. 4. Briefly comparing FIG. 3 and FIG. 4, attention is drawn to the fact that all of components 101 through 104 and 106 through 150 identified on FIG. 3 are portrayed in FIG. 4 and operate as described in the first embodiment. In lieu of distribution manifold 105 on FIG. 3 however, two-way fluid valve 160, left distribution manifold 162, right distribution manifold 161, spray sequence controller 165, and spray sequence selector means 166, such as a switch, capacitive touch sensor, or resistive touch sensor are provided. Also in lieu of pressurized spray lines 151 on FIG. 3, left pressurized spray lines 164 and right pressurized spray lines 163 are substituted in this second embodiment.

Turning now to FIG. 4, in this embodiment left distribution manifold 162 and right distribution manifold 161 have, in total, a number of output ports coextensive with the number of spray ports 134, 135, 136, 137, and 138 on the left and right sides of helmet 101, respectively. Two-way fluid valve 160 is an electrically operated “Y” valve that controls the flow of pressurized water and/or therapeutic fluids and/or substances delivered by second pumping means 103 to its input port delivering them to one, or both, of its output ports. In this embodiment, one output port of two-way fluid valve 160 is connected to the input port of left distribution manifold 162 and the other is connected to the input port of right distribution manifold 161. The output ports of left distribution manifold 162 are thence connected via left pressurized spray lines 164 to spray ports 134, 135, 136, 137, and 138 on the left side of helmet 101 and the output ports of right distribution manifold 161 are thence connected via right pressurized spray lines 163 connected to spray ports 134, 135, 136, 137, and 138 on the right side of helmet 101. Spray sequence controller 165 contains a central processing unit, read-only memory pre-loaded with executable instructions operable on the central processing unit, and at least two digitally activated analog switches. Spray sequence controller 165 is connected to power supply 108, spray sequence selector means 166, such as a switch, capacitive touch sensor, or resistive touch sensor, and two-way fluid valve 160 such that one digitally activated analog switch causes two-way fluid valve 160 to emit fluid from its first output port and a second digitally activated analog switch causes two-way fluid valve 160 to emit fluid from its second output port. Spray sequence selector means 166 may be mounted in a separate control housing or on the decorative shroud that encloses the entire device.

This embodiment of the present invention operates like the first embodiment, except as follows: When the user applies power to the device, spray sequence controller 165 is energized and assumes its base state, specifically forcing both ports of two-way fluid valve 160 to open so that fluid pumped via second pumping means 103 passes through two-way fluid valve 160 into both left distribution manifold 162 and right distribution manifold 161 and fluid is discharged through spray ports 134, 135, 136, 137, and 138 on both sides of helmet 101. Subsequently, the user actuates spray sequence selector means 166 to sequentially step through various preprogrammed spray sequences wherein, for example, two-way spray sequence controller 165 might allow fluid to be expelled from: 1) spray ports 134, 135, 136, 137, and 138 on the left side of helmet 101; 2) Spray ports 134, 135, 136, 137, and 138 on the right side of helmet 101; 3) Spray ports 134, 135, 136, 137, and 138 in both regions of helmet 101; or, 4) Rhythmically or arrhythmically expel fluid from: i) spray ports 134, 135, 136, 137, and 138 on the left side of helmet 101; and, ii) Spray ports 134, 135, 136, 137, and 138 on the right side of helmet 101; in a continuous repeating sequence, and so on.

It will be readily apparent to those having skill in the art that numerous alternative means of interconnecting the output ports of two-way fluid valve 160 to the multiplicity of spray ports 134, 135, 136, 137, and 138 are readily conceivable. For example, it is possible that the tube connection point of all of the multiplicity of spray ports 134, 135, 136, 137, and 138 on the right side of helmet 101 except one should be in the form of a “T” whereby one output port of two-way fluid valve 160 is connected directly to a first right-hand side spray port with a “T” connection, which is in turn connected to the next right-hand side spray port with a “T” connection, and so on, until the right-hand side spray port without a “T” connection is last connected to the penultimate right-hand side spray port in the chain with a “T” connection. By this means, it is possible to eliminate the need for right distribution manifold 161. Similarly, it is possible that the tube connection point of all of the multiplicity of spray ports 134, 135, 136, 137, and 138 on the left side of helmet 101 except one should be in the form of a “T” whereby the other output port of two-way fluid valve 160 is connected directly to a first left-hand side spray port with a “T” connection, which is in turn connected to the next left-hand side spray port with a “T” connection, and so on, until the left-hand side spray port without a “T” connection is last connected to the penultimate left-hand side spray port in the chain with a “T” connection. By this means, it is possible to eliminate the need for left distribution manifold 162.

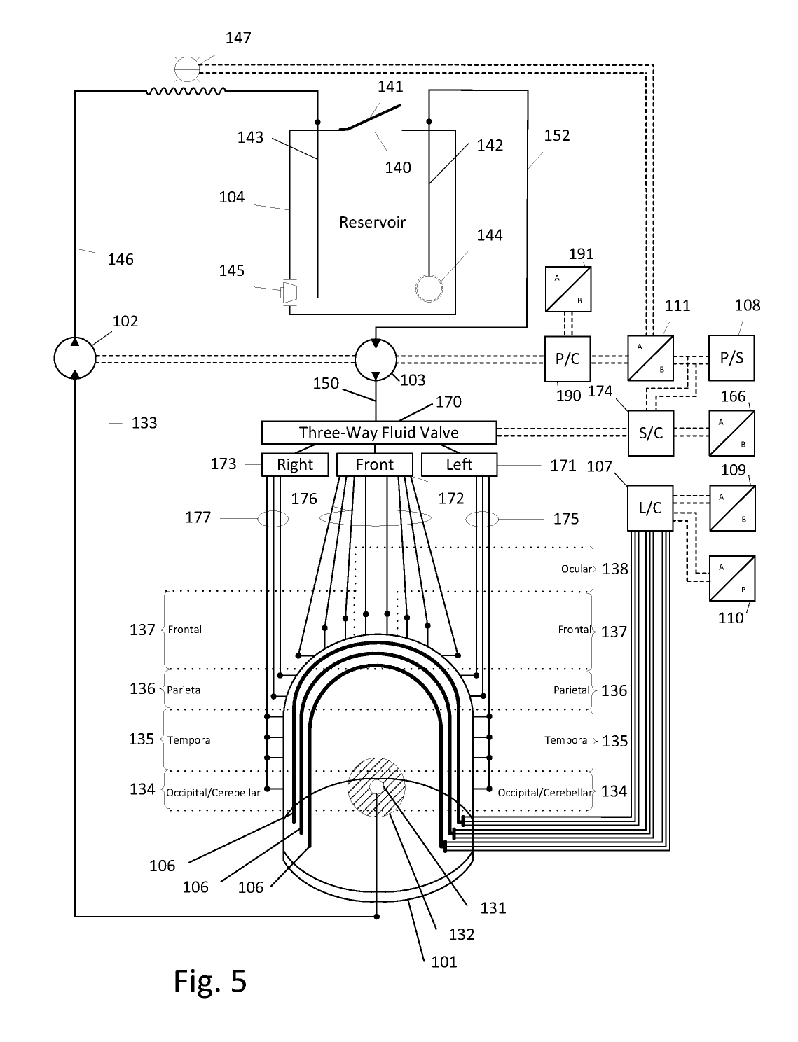

A third embodiment of the present invention is disclosed in FIG. 5. Briefly comparing FIG. 3 and FIG. 5, attention is drawn to the fact that all of components 101 through 104 and 106 through 150 identified on FIG. 3 are portrayed in FIG. 5 and operate as described in the first embodiment. In lieu of distribution manifold 105 on FIG. 3 however, three-way fluid valve 170, left side distribution manifold 171, front distribution manifold 172, right side distribution manifold 173, three-way spray sequence controller 174, and spray sequence selector means 166, such as a switch, capacitive touch sensor, or resistive touch sensor are provided. Also in lieu of pressurized spray lines 151 on FIG. 3, left side pressurized spray lines 175, front pressurized spray lines 176, and right side pressurized spray lines 177 are substituted in this third embodiment.

Turning now to FIG. 5, in this embodiment, left side distribution manifold 171 and right side distribution manifold 173 have, in total, a number of output ports coextensive with the number of spray ports 134, 135, and 136 on the left and right sides of helmet 101, while front distribution manifold 172 has a number of output ports coextensive in number with the number of spray ports 137 and 138 associated with those regions of helmet 101 adjacent to the frontal and ocular aspect of the front-central portion of the user's head and face. Three-way fluid valve 170 is an electrically operated “three-way” valve that controls the flow of pressurized water and/or therapeutic fluids and/or substances delivered by second pumping means 103 to its input port delivering them to the first, second, third, any two output ports simultaneously, or all three of its output ports simultaneously. In this embodiment, one output port of the three-way fluid valve is connected to the input port of left side distribution manifold 171, the second is connected to front distribution manifold 172, and the third is connected to the input port of right distribution manifold 173. The output ports of left side distribution manifold 171 are thence connected via left side pressurized spray lines 175 to spray ports 134, 135, and 136 on the left side of helmet 101 and the output ports of right side distribution manifold 173 are thence connected via right side pressurized spray lines 177 to spray ports 134, 135, and 136 on the right side of helmet 101. The output ports of front distribution manifold 172 are thence connected via front pressurized spray lines 176 to spray ports 137 and 138 associated with those regions of helmet 101 adjacent to the frontal and ocular aspect of the front-central portion of the user's head and face. Three-way spray sequence controller 174 contains a central processing unit, read-only memory pre-loaded with executable instructions operable on the central processing unit, and at least three digitally activated analog switches. Three-way spray sequence controller 174 is connected to power supply 108, spray sequence selector means 166, such as a switch, capacitive touch sensor, or resistive touch sensor, and three-way fluid valve 170 such that one digitally activated analog switch causes three-way fluid valve 170 to emit fluid from its first output port, the second digitally activated analog switch causes three-way fluid valve 170 to emit fluid from its second output port, and the third digitally activated analog switch causes three-way fluid valve 170 to emit fluid from its third output port. Spray sequence selector means 166 may be mounted in a separate control housing or on the decorative shroud that encloses the entire device.

This embodiment of the present invention operates like the first embodiment, except as follows: When the user applies power to the device, three-way spray sequence controller 174 is energized and assumes its base state, specifically forcing all three ports of three-way fluid valve 170 to open so that fluid pumped via second pumping means 103 passes through three-way fluid valve 170 into left side distribution manifold 171, front distribution manifold 172, and right side distribution manifold 173 and fluid is discharged through all of spray ports 134, 135, 136, 137, and 138. Subsequently, the user actuates spray sequence selector means 166 to sequentially step through various preprogrammed spray sequences wherein, for example, three-way spray sequence controller 174 might allow fluid to be expelled from: 1) spray ports 134, 135, and 136 on the left side of helmet 101; 2) Spray ports 137 and 138 on the front of helmet 101; 3) Spray ports 134, 135, and 136 on the right side of helmet 101; 4) Spray ports 134, 135, 136, 137, and 138 in all regions of helmet 101; or, 5) Rhythmically or arrhythmically expel fluid from: i) spray ports 134, 135, and 136 on the left side of helmet 101; ii) Spray ports 137 and 138 on the front of helmet 101; and, iii) Spray ports 134, 135, and 136 on the right side of helmet 101 in a continuous repeating sequence, and so on.

It will be readily apparent to those having skill in the art that numerous alternative means of interconnecting the output ports of three-way fluid valve 170 to the multiplicity of spray ports 134, 135, 136, 137, and 138 are readily conceivable. For example, it is possible that the tube connection point of all of the multiplicity of spray ports 134, 135, and 136 on the right-hand side of helmet 101 except one should be in the form of a “T” whereby the first output port of three-way fluid valve 170 is connected directly to a first right-hand side spray port with a “T” connection, which is in turn connected to the next right-hand side spray port with a “T” connection, and so on, until the right-hand side spray port without a “T” connection is last connected to the penultimate right-hand side spray port in the chain with a “T” connection. By this means, it is possible to eliminate the need for right-side distribution manifold 173. Similarly, it is possible that the tube connection point of all of the multiplicity of spray ports 134, 135, and 136 on the left-hand side of helmet 101 except one should be in the form of a “T” whereby the second output port of three-way fluid valve 170 is connected directly to a first left-hand side spray port with a “T” connection, which is in turn connected to the next left-hand side spray port with a “T” connection, and so on, until the left-hand side spray port without a “T” connection is last connected to the penultimate left-hand side spray port in the chain with a “T” connection. By this means, it is possible to eliminate the need for left-side distribution manifold 171. By the same token, it is possible that the tube connection point of all of the multiplicity of spray ports 137 and 138 on the front of helmet 101 except one should be in the form of a “T” whereby the third output port of three-way fluid valve 170 is connected directly to a first front spray port with a “T” connection, which is in turn connected to the next front spray port with a “T” connection, and so on, until the front spray port without a “T” connection is last connected to the penultimate front side spray port in the chain with a “T” connection. By this means, it is possible to eliminate the need for front distribution manifold 172.

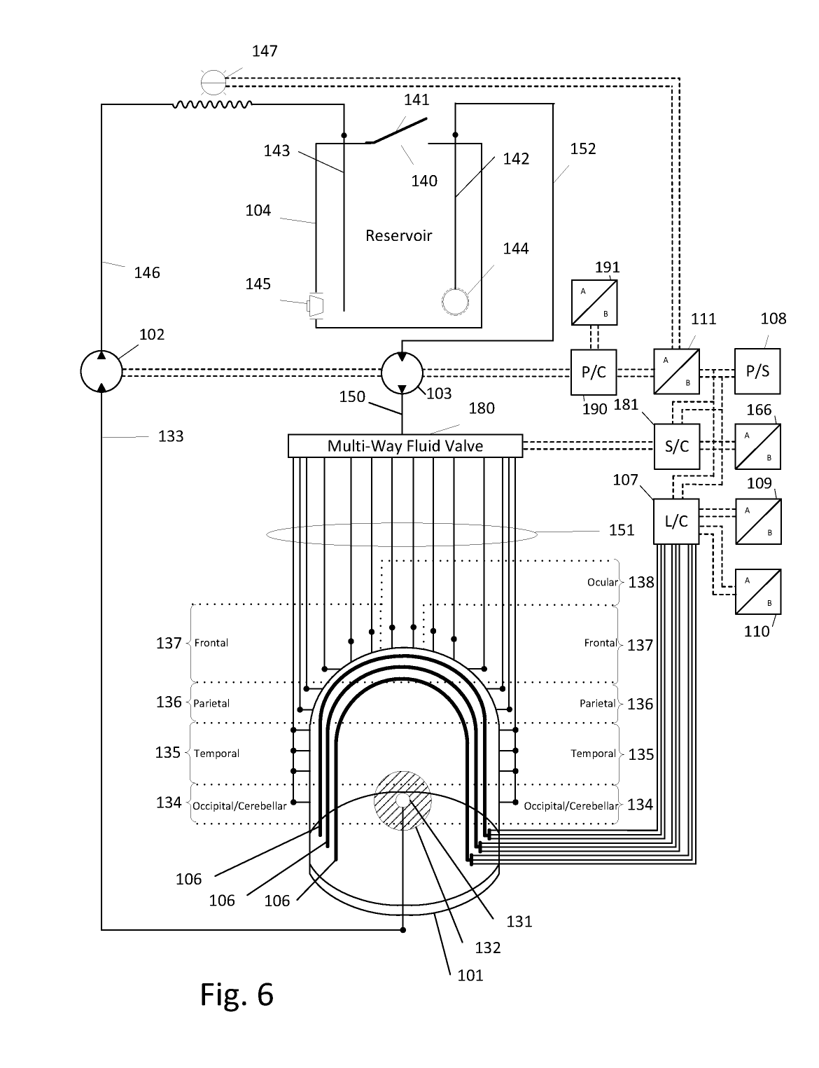

A fourth embodiment of the present invention is disclosed in FIG. 6. Briefly comparing FIG. 3 and FIG. 6, attention is drawn to the fact that all of components 101 through 104 and 106 through 151 identified on FIG. 3 are portrayed in FIG. 6 and operate as described in the first embodiment. In lieu of distribution manifold 105 on FIG. 3 however, multi-port fluid valve 180, multi-port spray sequence controller 181, and spray sequence selector means 166, such as a switch, capacitive touch sensor, or resistive touch sensor are provided.

Turning now to FIG. 6, multi-port fluid valve 180 is an electrically operated “multi-way” valve with a number of output ports coextensive in number with the number of spray ports 134, 135, 136, 137, and 138 in helmet 101. Multi-port fluid valve 180 controls the flow of pressurized water and/or therapeutic fluids and/or substances from its input port to one or any multiplicity of its output ports. Multi-port fluid valve 180 is equipped with a digital signaling and power interface interconnectable with a similar digital signaling and power interface on multi-port spray sequence controller 181. In this embodiment, each output port of multi-port fluid valve 180 is connected to each of the tube attachment points present on the outer surface of helmet 101 where spray ports 134, 135, 136, 137, and 138 perforate helmet 101. Multi-port spray sequence controller 181 contains a central processing unit, read-only memory pre-loaded with executable instructions operable on the central processing unit, and a digital signaling and power interface interconnectable with a similar digital signaling and power interface on multi-port fluid valve 180 thus providing a means for multi-port spray sequence controller 181 to power and control multi-port fluid valve 180. Multi-port spray sequence controller 181 is connected to power supply 108 and spray sequence selector means 166, such as a switch, capacitive touch sensor, or resistive touch sensor, and multi-port fluid valve 180 via the aforementioned digital signaling and power interface such that multi-port spray sequence controller 181 causes multi-port fluid valve 180 to emit fluid from one, all, or any arbitrary subset, of its output ports. Spray sequence selector means 166 may be mounted in a separate control housing or on the decorative shroud that encloses the entire device.

This embodiment of the present invention operates like the first embodiment, except as follows: When the user applies power to the device, multi-port spray sequence controller 181 is energized and assumes its base state, specifically forcing all ports of multi-port fluid valve 180 to open so that fluid pumped via second pumping means 103 passes through multi-port fluid valve 180 to be discharged through all of spray ports 134, 135, 136, 137, and 138. Subsequently, the user actuates spray sequence selector means 166 to sequentially step through various preprogrammed spray sequences wherein multi-port spray sequence controller 181 directs multi-port fluid valve 180 to rhythmically or arrhythmically allow fluid to be expelled from spray ports 134, 135, 136, 137, and 138 or any arbitrary subset of spray ports 134, 135, 136, 137, and 138 on helmet 101. By this means, a, infinite number of pleasing and stimulating spray actuation patterns and timing sequences may be created and enjoyed by the user. For example, patterns emulating those generated by the first, second, and third embodiments of the present invention (i.e. whole head spray, left-side/front right-side/front head spray, and left-side, front, and right-side spray, respectively) are easily implemented. Also, new spray patterns are easily conceivable. One example, without limitation, would be a pattern that sequentially stimulates the occipital/parietal region of the user's head followed in sequence by the parietal, temporal, frontal, and ocular regions of the user's head, respectively. Patterns that apply varying types of stimulation to a particular region, or regions, are readily conceivable. For example, a pattern that uses individual spray ports to trace out a rotating path on the user's left and right temporal areas, or alternates between the user's left and right temporal areas, or alternates between the user's left and right temporal areas several times before applying fluid to frontal and ocular areas, and so on, are easily created.

Referring now to FIGS. 1, 2, 3, and 4, in another embodiment, an optional pump pressure controller 190 and a pump pressure selector means 191, such as a switch, capacitive touch sensor, or resistive touch sensor are provided to vary the output pressure of fluid delivered by second pumping means 103. While pump pressure controller 190 is preferably implemented as a conventional analog control circuit capable of varying the power supplied to first pumping means 102 and second pumping means 103 to vary the speed, and thus pressure, at which they operate, pump pressure controller 190 may alternately contain a central processing unit, a read-only memory pre-loaded with executable instructions operable on the central processing unit, and a digital to analog control interface capable of varying the power supplied to first pumping means 102 and second pumping means 103 to continuously vary the speed, and thus pressure, at which they operate. Pump pressure selector means 191 may be mounted in a separate control housing or on the decorative shroud that encloses the entire device and is connected to the pump pressure controller 190, power supply 108, first pumping means 102, and second pumping means 103. This embodiment of the present invention operates like the first embodiment, except as follows: If pump pressure controller 190 comprises a conventional analog control circuit capable of varying the power supplied to first pumping means 102 and second pumping means 103, when the user applies power to the device pump pressure controller 190 sets first pumping means 102 and second pumping means 103 in operation at their lowest speed and pressure. The user then actuates pump pressure selector means 191 to cause pump pressure controller 190 to increase pressure levels in a stepped sequence. Alternately, if pump pressure controller 190 comprises a central processing unit, a read-only memory pre-loaded with executable instructions operable on the central processing unit, and a digital to analog control interface capable of varying the power supplied to first pumping means 102 and second pumping means 103, when the user applies power to the device, pump pressure controller 190 is energized and assumes its base state, setting first pumping means 102 and second pumping means 103 in operation at their lowest speed and pressure. The user then actuates pump pressure selector means 191 to cause the pump pressure controller 190 to increase pressure levels in preprogrammed stepped sequences or to operate in one of a number of preprogrammed sequences providing a repeating, rhythmic pattern of physical stimulation.

In another embodiment, a plastic or rubber curtain or dam is attached to the decorative shroud that encloses the entire device such that when the shroud is installed and a user's head and neck is inserted, the user's face, chin, and neck with the exception of the oronasal area of the face is covered. This curtain or dam is provided to limit the amount of fluid inadvertently sprayed outside the device when operating the invention at higher pump pressures.

In another embodiment, that portion of helmet 101 in which ocular spray jets 138 are located may take the form of an opaque or translucent face shield hingedly attached to helmet 101. This face shield flips up and over to allow the user to insert his head and flips down to cover the eyes.

In another embodiment, ocular spray jets 138 may be omitted from the aforementioned face shield. In lieu, a means for containing and applying therapeutic gel, such as a pad or sponge, to the facial area around the user's eyes is removably affixed to the inner side of the aforementioned face shield.

In another embodiment, ocular spray jets 138 may be omitted from the aforementioned face shield. Instead, a display device such as an LCD or LED display with an appropriate optical system: 1) Capable of displaying digital or computer generated images and/or light patterns focused at infinity; or, 2) Equipped with an optical or electronic (e.g. nematic) lens system capable of focusing generated images for particular users. Such a display is affixed to the inner aspect of the face shield in such a manner that sprayed fluid is prevented from being deposited on the display or supporting optical systems. In this embodiment the face shield flips up to allow the user to insert his or her head and flips down to cover the eyes. Digital images and/or light patterns generated by a computer may be displayed on the display for the user to perceive and enjoy.

In another embodiment reservoir 104 may be externally removed from the device and interconnected with the remaining parts of the device by means of extended-length pressurized drain line 146 and suction feed line 152. Indeed, reservoir 104 may be completely absent from the device with extended-length pressurized drain line 146 and suction feed line 152 terminating in a nearby sink or basin.

In another embodiment an electrical device to heat and/or cool the water and/or therapeutic fluids and/or substances in reservoir 104 may be installed in reservoir 104 or suction feed line 152.

In another embodiment, speakers for reproducing sound and music may be mounted in sealed cavities between helmet 101 and the decorative shroud enclosing the entire device such that the speakers are acoustically exposed to the inside of helmet 101 and directed at the user's ears such that relaxing and pleasing music or sound may be reproduced so that the user may hear and enjoy it.

In another embodiment, a ventilation port for admitting air or other gasses into helmet 101 is provided. Air may be provided by any of the conventional means, i.e. by a fan or blower and may be warmed by an electrical heating element or cooled by a refrigerated air system. Further, ventilating air may be admixed with oxygen or other compressed gasses to provide an altered atmospheric environment inside helmet 101.

In another embodiment, a port for admitting concentrated odoriferous vapors into helmet 101 is provided. The port is located on one of the exposed outside surfaces of helmet 101 and comprises, in order from the outside of helmet 101: 1) An exposed outside cover; 2) An underlying diffuser chamber; 3) One or more fabric or synthetic diffuser pads inside the diffuser chamber; and, 4) A perforated diffuser screen segregating the diffuser chamber and diffuser pads away from the interior of helmet 101 yet allowing the passage of odoriferous vapors from diffuser pad(s) contained in the diffuser chamber into the interior of helmet 101. The user may enjoy aromatherapy, in concert with fluid and/or chromotherapy by: 1) Temporarily removing the exposed outside cover; 2) Applying one or more concentrated odoriferous oil(s) to the enclosed diffuser pad; and, 3) Replacing the exposed outside cover to seal the diffuser chamber. By this means, odoriferous vapors diffuse from the diffuser pad and through the perforated diffuser screen to the interior of helmet 101.

While the invention has been described in connection with what are considered to be the most practical and preferred embodiments, it is to be understood that the invention is not to be limited to the disclosed embodiments, variants, and sub-variants, but on the contrary is intended to cover various modifications and equivalent arrangements included within the spirit and scope of the disclosure.

What is claimed is:

1. A portable relaxation therapy device for the head, comprising:
a. a helmet in the general form of a cylinder with domed terminal portion open at the bottom and front such that when the head is inserted said helmet encloses the entirety of the head and neck with the exception of the anterior area of the face below the nose and the anterior portion of the neck;
i. wherein said helmet is fixedly disposed such that the open area exposing said anterior area of the face below the nose and the anterior portion of the neck generally points up;
ii. wherein said helmet has a multiplicity of spray ports arrayed around its interior aspect, each one of which communicates through said helmet and terminates at a spray tube connection point;
iii. wherein said helmet has at least one drain port installed through the lower part of its interior aspect, each of said drain ports communicating through said helmet and terminating at a drain tube connection point;
iv. wherein said helmet has a pad affixed to its interior aspect approximately adjacent to the posterior aspect of the head;
b. a reservoir with sealable access door on its upper aspect and sealable drain port on its lower aspect;
i. wherein said reservoir internally comprises a suction pickup line originating in the lower aspect of said reservoir and extending up and communicating through the wall of said reservoir on its upper aspect terminating at a suction pickup line connection point;
ii. wherein said reservoir internally comprises a drain discharge line originating in the lower aspect of said reservoir and extending up and communicating through the wall of said reservoir on its upper aspect terminating at a drain discharge line connection point;
c. a fluid distribution manifold with one manifold input tube connection point and a multiplicity of manifold output tube connection points coextensive in number with the number of said spray tube connection points;
d. a first pumping means hydraulically connected between said drain tube connection point and said drain discharge line connection point for transporting fluid deposited in the posterior aspect of said helmet to said reservoir;
e. a second pumping means hydraulically connected between said manifold input tube connection point and said suction pickup line connection point for transporting fluid in said reservoir to said fluid distribution manifold; and
f. a multiplicity of hydraulic connections between said manifold output tube connection points and said spray tube connection points for transporting fluid from said manifold to said spray ports.

2. The portable relaxation therapy device for the head of claim 1, further comprising:
a. a multiplicity of sources of monochromatic light arrayed around the interior aspect of said helmet;
b. a light control unit electrically connected to a source of electric power and multiplicity of said sources of monochromatic light capable of varying the intensity of the light generated by them; and
c. an intensity control means electrically connected to said light control unit capable of causing it to vary the intensity of the light generated by the multiplicity of said sources of monochromatic colored light.

3. The portable relaxation therapy device for the head of claim 1, further comprising:
a. a multiplicity of sources of multiple colors of light arrayed around the interior aspect of said helmet;
b. a light control unit electrically connected to a source of electric power and multiplicity of said sources of multiple colors of light capable of varying the color and intensity of the light generated by them;
c. a color control means electrically connected to said light control unit capable of causing it to vary the color of the light generated by the multiplicity of said sources of multiple colors of light; and
d. an intensity control means electrically connected to said light control unit capable of causing it to vary the intensity of the light generated by the multiplicity of said sources of multiple colors of light.

4. The portable relaxation therapy device for the head of claim 1 further comprising:
a. a pressurized drain line comprised of an ultraviolet radiation resistant transparent material;
b. a source of ultraviolet light placed in intimate proximity to said pressurized drain line; and
c. wherein said source of ultraviolet light is electrically connected to said switching means capable of simultaneously supplying electric power to said first pumping means and said second pumping means such that said switching means simultaneously supplies electric power to said source of ultraviolet radiation.

5. The portable relaxation therapy device for the head of claim 1, further comprising:
a. a pump pressure control unit electrically connected to a source of electric power, said first pumping means, and said second pumping means; and
b. a pump pressure control means electrically connected to said pump pressure control unit capable of causing it to vary the speed and thus output pressure of said first pumping means and said second pumping means.

6. A portable relaxation therapy device for the head, comprising:
a. a helmet in the general form of a cylinder with domed terminal portion open at the bottom and front such that when the head is inserted said helmet encloses the entirety of the head and neck with the exception of the anterior area of the face below the nose and the anterior portion of the neck;
i. wherein said helmet is fixedly disposed such that the open area exposing said anterior area of the face below the nose and the anterior portion of the neck generally points up;
ii. wherein said helmet has a multiplicity of spray ports arrayed around its interior aspect, each one of which communicates through said helmet and terminates at a spray tube connection point;
iii. wherein said helmet has at least one drain port installed through the lower part of its interior aspect, each of said drain ports communicating through said helmet and terminating at a drain tube connection point;
iv. wherein said helmet has a pad affixed to its interior aspect approximately adjacent to the posterior aspect of the head;
b. a reservoir with sealable access door on its upper aspect and sealable drain port on its lower aspect;
i. wherein said reservoir internally comprises a suction pickup line originating in the lower aspect of said reservoir and extending up and communicating through the wall of said reservoir on its upper aspect terminating at a suction pickup line connection point;
ii. wherein said reservoir internally comprises a drain discharge line originating in the lower aspect of said reservoir and extending up and communicating through the wall of said reservoir on its upper aspect terminating at a drain discharge line connection point;
c. at least two fluid distribution manifolds each one with a manifold input tube connection point and at least one manifold output tube connection point such that the total number of said manifold output tube connection points extant on all of said fluid distribution manifolds is coextensive in number with the number of said spray tube connection points;
d. an electric fluid valve with at least one valve input tube connection point and at least two valve output tube connection points coextensive in number to the number of fluid distribution manifolds;
i. wherein said electric fluid valve distributes fluid to any one or any multiplicity of its valve output tube connection points;
ii. wherein said electric fluid valve is electrically connected to a spray sequence controller wherein the selection of which one, or multiplicity of, said electric fluid valve's output tube connection points emit fluid is controlled by said spray sequence controller;
iii. wherein said spray sequence controller is electrically connected to a source of electric power and to a spray sequence selector means capable of causing said spray sequence controller to cause said electric fluid valve to vary the selection of valve output tube connection points that emit fluid;
e. a first pumping means hydraulically connected between said drain tube connection point and said drain discharge line connection point for transporting fluid deposited in the posterior aspect of said helmet to said reservoir;
f. a second pumping means hydraulically connected between said valve input tube connection point and said suction pickup line connection point for transporting fluid in said reservoir to said electric fluid valve;
g. a switching means capable of simultaneously supplying electric power to said first pumping means and said second pumping means;
h. a multiplicity of hydraulic connections between said valve output tube connection points and said manifold input tube connection points for transporting fluid from said electric fluid valve to said fluid distribution manifolds; and
i. a multiplicity of hydraulic connections between said manifold output tube connection points and said spray tube connection points for transporting fluid from said fluid distribution manifolds to said spray ports.

7. The portable relaxation therapy device for the head of claim 6, further comprising:
a. a multiplicity of sources of monochromatic light arrayed around the interior aspect of said helmet;
b. a light control unit electrically connected to a source of electric power and multiplicity of said sources of monochromatic light capable of varying the intensity of the light generated by them; and
c. an intensity control means electrically connected to said light control unit capable of causing it to vary the intensity of the light generated by the multiplicity of said sources of monochromatic colored light.

8. The portable relaxation therapy device for the head of claim 6 further comprising:
a. a multiplicity of sources of multiple colors of light arrayed around the interior aspect of said helmet;
b. a light control unit electrically connected to a source of electric power and multiplicity of said sources of multiple colors of light capable of varying the color and intensity of the light generated by them;
c. a color control means electrically connected to said light control unit capable of causing it to vary the color of the light generated by the multiplicity of said sources of multiple colors of light; and
d. an intensity control means electrically connected to said light control unit capable of causing it to vary the intensity of the light generated by the multiplicity of said sources of multiple colors of light.

9. The portable relaxation therapy device for the head of claim 6 further comprising:
a. a pressurized drain line comprised of an ultraviolet radiation resistant transparent material;
b. a source of ultraviolet light placed in intimate proximity to said pressurized drain line; and
c. wherein said source of ultraviolet light is electrically connected to said switching means capable of simultaneously supplying electric power to said first pumping means and said second pumping means such that said switching means simultaneously supplies electric power to said source of ultraviolet radiation.

10. The portable relaxation therapy device for the head of claim 6 further comprising:
a. a pump pressure control unit electrically connected to a source of electric power, said first pumping means, and said second pumping means; and
b. a pump pressure control means electrically connected to said pump pressure control unit capable of causing it to vary the speed and thus output pressure of said first pumping means and said second pumping means.

11. A portable relaxation therapy device for the head, comprising:
a. a helmet in the general form of a cylinder with domed terminal portion open at the bottom and front such that when the head is inserted said helmet encloses the entirety of the head and neck with the exception of the anterior area of the face below the nose and the anterior portion of the neck;
i. wherein said helmet is fixedly disposed such that the open area exposing said anterior area of the face below the nose and the anterior portion of the neck generally points up;
ii. wherein said helmet has a multiplicity of spray ports arrayed around its interior aspect, each one of which communicates through said helmet and terminates at a spray tube connection point;
iii. wherein said helmet has at least one drain port installed through the lower part of its interior aspect, each of said drain ports communicating through said helmet and terminating at a drain tube connection point;
iv. wherein said helmet has a pad affixed to its interior aspect approximately adjacent to the posterior aspect of the head;
b. a reservoir with sealable access door on its upper aspect and sealable drain port on its lower aspect;
i. wherein said reservoir internally comprises a suction pickup line originating in the lower aspect of said reservoir and extending up and communicating through the wall of said reservoir on its upper aspect terminating at a suction pickup line connection point;
ii. wherein said reservoir internally comprises a drain discharge line originating in the lower aspect of said reservoir and extending up and communicating through the wall of said reservoir on its upper aspect terminating at a drain discharge line connection point;
c. an electric fluid valve with at least one valve input tube connection point and at least two valve output tube connection points coextensive in number to the number of fluid distribution manifolds;
i. wherein said electric fluid valve distributes fluid to any one or any multiplicity of its valve output tube connection points;
ii. wherein said electric fluid valve is electrically connected to a spray sequence controller wherein the selection of which one, or multiplicity of, said electric fluid valve's output tube connection points emit fluid is controlled by said spray sequence controller;
iii. wherein said spray sequence controller is electrically connected to a source of electric power and to a spray sequence selector means capable of causing said spray sequence controller to cause said electric fluid valve to vary the selection of valve output tube connection points that emit fluid;
d. a first pumping means hydraulically connected between said drain tube connection point and said drain discharge line connection point for transporting fluid deposited in the posterior aspect of said helmet to said reservoir;
e. a second pumping means hydraulically connected between said valve input tube connection point and said suction pickup line connection point for transporting fluid in said reservoir to said electric fluid valve;
f. a switching means capable of simultaneously supplying electric power to said first pumping means and said second pumping means; and
g. a multiplicity of hydraulic connections between said valve output tube connection points and said spray tube connection points for transporting fluid from said electric fluid valve to said spray ports.

12. The portable relaxation therapy device for the head of claim 11, further comprising:
a. a multiplicity of sources of monochromatic light arrayed around the interior aspect of said helmet;
b. a light control unit electrically connected to a source of electric power and multiplicity of said sources of monochromatic light capable of varying the intensity of the light generated by them; and
c. an intensity control means electrically connected to said light control unit capable of causing it to vary the intensity of the light generated by the multiplicity of said sources of monochromatic colored light.

13. The portable relaxation therapy device for the head of claim 11 further comprising:
a. a multiplicity of sources of multiple colors of light arrayed around the interior aspect of said helmet;
b. a light control unit electrically connected to a source of electric power and multiplicity of said sources of multiple colors of light capable of varying the color and intensity of the light generated by them;
c. a color control means electrically connected to said light control unit capable of causing it to vary the color of the light generated by the multiplicity of said sources of multiple colors of light; and
d. an intensity control means electrically connected to said light control unit capable of causing it to vary the intensity of the light generated by the multiplicity of said sources of multiple colors of light.

14. The portable relaxation therapy device for the head of claim 11 further comprising:
a. a pressurized drain line comprised of an ultraviolet radiation resistant transparent material;
b. a source of ultraviolet light placed in intimate proximity to said pressurized drain line; and
c. wherein said source of ultraviolet light is electrically connected to said switching means capable of simultaneously supplying electric power to said first pumping means and said second pumping means such that said switching means simultaneously supplies electric power to said source of ultraviolet radiation.

15. The portable relaxation therapy device for the head of claim 11 further comprising:
a. a pump pressure control unit electrically connected to a source of electric power, said first pumping means, and said second pumping means; and
b. a pump pressure control means electrically connected to said pump pressure control unit capable of causing it to vary the speed and thus output pressure of said first pumping means and said second pumping means.
